(19) United States
(12) Patent Application Publication
(10) Pub. No.: US 2009/0251455 A1
(43) Pub. Date: Oct. 8, 2009

(54) Flat panel display and method of driving the flat panel display

(76) Inventors: OK-KYUNG PARK, Suwon-si (KR); MI-HAE KIM, Suwon-si (KR); SEON-I JEONG, Suwon-si (KR); CHANG-SOO PYON, Suwon-si (KR); SAM-IL HAN, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/382,295

(22) Filed: Mar. 12, 2009

(30) Foreign Application Priority Data
Apr. 2, 2008 (KR) 10-2008-0030904

(51) Int. Cl. G09G 3/34; G09G 5/00

(52) U.S. Cl. 345/214; 345/84

(57) ABSTRACT

A flat panel display sequentially supplying data signals to a pixel portion using a demultiplexer and a method of driving the flat panel sufficiently supply scan signals in a horizontal period to prevent deformation and distortion of the data signal supplied to each pixel and compensate for a threshold voltage of a drive transistor of the pixel. The flat panel display includes a pixel portion having a plurality of pixels, a scan driver to supply scan signals to the pixel portion, a data driver to generate data signals, a dimultiplexer portion to sequentially supply the data signals to the pixel portion, and a lighting tester to supply a lighting test signal and an initialization signal to the pixel portion. Alternatively, the flat panel display includes a pixel portion having a plurality of pixels, a scan driver to supply scan signals to the pixel portion, a data driver to output data signals and a dimultiplexer portion to sequentially supply an initialization signal and the data signal to the pixel portion.

### CLAIM OF PRIORITY

This application makes reference to, incorporates the same herein, and claims all benefits accruing under 35 U.S.C. §119 from an application for FLAT PANEL DISPLAY DEVICE AND METHOD OF DRIVING THE SAME earlier filed in the Korean Intellectual Property Office on 2 Apr. 2008 and there duly assigned Serial No. 2008-0030904.

### BACKGROUND OF THE INVENTION

1. Field of the Invention

The present invention relates to a flat panel display and a method of driving the flat panel display, and more particularly, the present invention relates to a flat panel display sequentially supplying data signals to a pixel portion using a dimultiplexer and a method of driving the flat panel display, supplying scan signals in a horizontal period to prevent deformation and distortion of the data signal supplied to each pixel and compensating for a threshold voltage of a drive transistor of the pixel.

2. Description of the Related Art

Since flat panel displays are lightweight and thin, they are used as alternatives to Cathode-Ray Tube (CRT) displays. Examples of flat panel displays include Liquid Crystal Displays (LCDs), and Organic Light Emitting Diode (OLED) displays.

The OLED displays generate excitons by recombination of electrons and holes, which are injected through a cathode and an anode, into an organic thin film, and emit light having a predetermined wavelength due to energy from the excitons. The OLED displays have high brightness and a wide viewing angle, and can be embodied in an ultra slim shape because they do not need a back-light.

In the flat panel display, a plurality of pixels commonly connected to one scan line are connected to different data lines. Therefore, when the number of pixels arranged in directions of scan lines and data lines is increased for a higher resolution, the number of data lines is also increased in proportion to the number of pixels. As a result, the number of data drive circuits included in a data driver to supply data to the respective pixels through the plurality of data lines is increased, and thus the production cost is increased.

To solve these problems, data signals generated by the data driver are sequentially supplied to the plurality of data lines using a Demultiplexer (Demux) which can selectively output an input signal to one of a plurality of output lines, thereby reducing the number of data drive circuits included in the data driver.

However, the flat panel display using the demultiplexer is driven in one horizontal period divided into two durations, i.e., a record duration of data signals and an application duration of scan signals to allow the data signal to be supplied to each pixel, such that deformation of the data signals sequentially input due to the data signals which supplied to pixels during a previous horizontal period can be prevented.

Accordingly, in the flat panel display using the demultiplexer, the application duration of the scan signals during the horizontal period is relatively shorter as the resolution is increased. Thus, when each of the plurality of pixels includes a compensation circuit for preventing the distortion or deformation of the data signal supplied to each pixel and compensating for a threshold voltage of the drive transistor, the circuit cannot sufficiently ensure the application duration of the scan signals which are necessary to compensate for the threshold voltage of the drive transistor.

### SUMMARY OF THE INVENTION

Aspects of the present invention provide a flat panel display and a method of driving the flat panel display, which prevents distortion or deformation of a data signal supplied to each pixel, and ensures an application duration of scan signals to compensate for a threshold voltage of a drive transistor by supplying an initialization signal to a data line, not electrically connected to a data driver before or during the application of the scan signal to each pixel in one horizontal period, and to supply a data signal to each pixel during the application of the scan signal.

According to an embodiment of the present invention, a flat panel display includes: a pixel portion having a plurality of pixels; a scan driver to supply a scan signal to the pixel portion; a data driver to generate a data signal; a dimultiplexer portion to sequentially supply the data signal to the pixel portion; and a lighting tester to supply a lighting test signal and an initialization signal to the pixel portion.

According to another embodiment of the present invention, a flat panel display includes: a pixel portion having a plurality of pixels; a scan driver to supply a scan signal to the pixel portion; a data driver to output a data signal; and a dimultiplexer portion to sequentially supply an initialization signal and the data signal to the pixel portion.

According to still another embodiment of the present invention, a method of driving a flat panel display, including a scan driver, a data driver, a pixel portion having a plurality of pixels and a lighting tester, and sequentially supplying data signals to the pixel portion using a demultiplexer, the method including: supplying an initialization signal to a test interconnection of the lighting tester; electrically connecting the test interconnection to a plurality of data lines electrically connected to the pixel portion in response to a control signal of the lighting tester, and to supply the initialization signal to the pixel portion; supplying a scan signal to the pixel portion; and sequentially supplying a data signal to the pixel portion during the application of the scan signal.

According to yet another embodiment of the present invention, a method of driving a flat panel display, including a scan driver, a data driver and a pixel portion having a plurality of pixels, and sequentially supplying data signals to the pixel portion using a dimultiplexer, the method including: dividing one horizontal period into a first period and a second period; dividing a plurality of data lines electrically connecting the plurality of pixels and the dimultiplexer to a first group and a second group; supplying initialization signals to the data lines of the first group during the first period; sequentially supplying data signals to the data lines of the second group during the first period; supplying scan signals to the pixel portion during the second period; and sequentially supplying data signals to the data lines of the first group during the second period of supplying the scan signals.

According to yet another embodiment of the present invention, a method of driving a flat panel display including a scan driver, a data driver and a pixel portion having a plurality of pixels, and sequentially supplying data signals to the pixel portion using a dimultiplexer, the method including: supplying scan signals during one horizontal period; sequentially electrically connecting data lines to the pixel portion and the data driver in response to control signals; and electrically connecting at least one of the plurality of data lines, not connected to the data driver, to an initialization interconnection supplied with an initialization signal in response to the control signals.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a schematic view of a flat panel display according to a first exemplary embodiment of the present invention;

FIG. 2 is a circuit diagram of a lighting tester of the flat panel display according to the first exemplary embodiment of the present invention;

FIG. 3 is a circuit diagram of an example of a demultiplexer of the flat panel display according to the first exemplary embodiment of the present invention;

FIG. 4 is a timing diagram of signals supplied to the flat panel display according to the first exemplary embodiment of the present invention;

FIG. 5 is a circuit diagram of another example of a demultiplexer of the flat panel display according to the first exemplary embodiment of the present invention;

FIG. 6 is a timing diagram of signals supplied to the flat panel display including the demultiplexer illustrated in FIG. 5;

FIG. 7 is a schematic view of a flat panel display according to a second exemplary embodiment of the present invention;

FIG. 8 is a circuit diagram of a demultiplexer of the flat panel display according to the second exemplary embodiment of the present invention; and

FIG. 9 is a timing diagram of signals supplied to the flat panel display according to the second exemplary embodiment of the present invention.

### DETAILED DESCRIPTION OF THE INVENTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

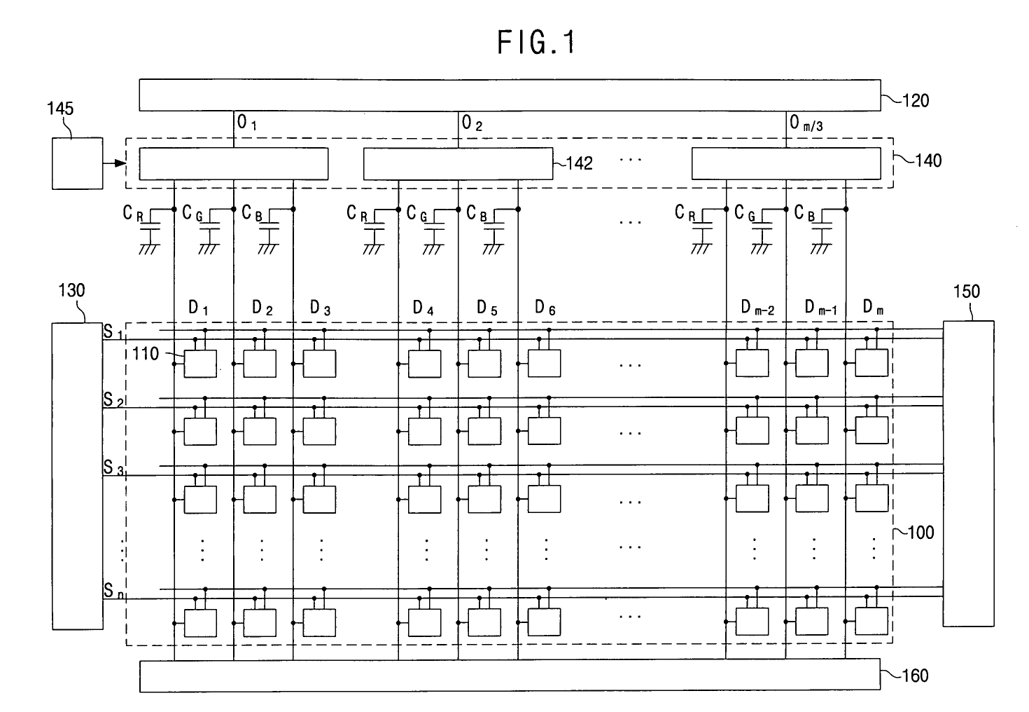

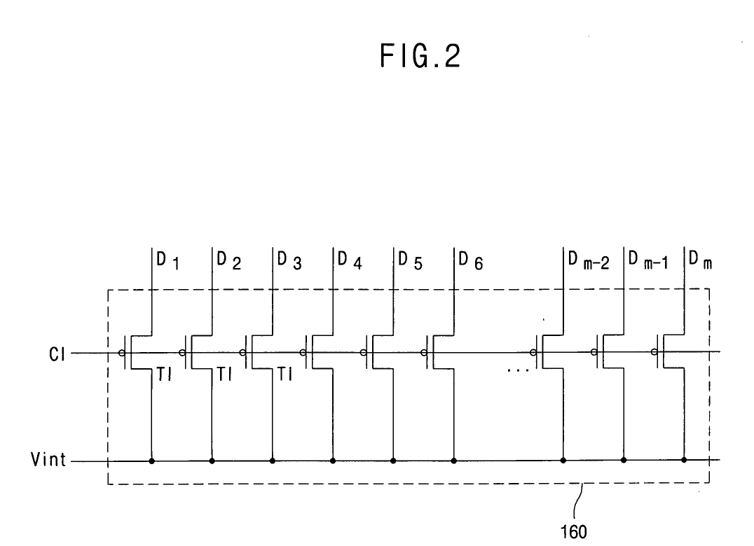

FIG. 1 is a schematic view of a flat panel display according to a first exemplary embodiment of the present invention, and FIG. 2 is a circuit diagram of a lighting tester of the flat panel display according to the first exemplary embodiment of the present invention.

Referring to FIGS. 1 and 2, the flat panel display according to the first exemplary embodiment includes a pixel portion 100 having a plurality of pixels 110, a scan driver 130 for supplying a scan signal to the pixel portion 100, a data driver 120 for outputting data signals to a plurality of output lines O₁ to O_{m/3}, a demultiplexer portion 140 having at least one demultiplexer 142 for receiving the data signals through the plurality of output lines O₁ to O_{m/3} and for sequentially supplying the data signals to the pixel portion 100 through a plurality of data lines D₁ to Dₘ, and a lighting tester 160 for supplying a lighting test signal or an initialization signal to the pixel portion 100.

The pixel portion 100 may include a blue pixel for displaying blue colors, a red pixel for displaying red colors and a green pixel for displaying green colors, and may further include a pixel (not illustrated) for displaying colors other than the red, green and blue colors.

The data driver 120 converts a digital image signal received from a timing controller (not illustrated) into a data signal, and supples the data signal to the demultiplexer portion 140, and the demultiplexer 142 of the demultiplexer portion 140 sequentially supplies the data signal to the pixel portion through the plurality of data lines D₁ to Dₘ electrically connected to the pixel portion 100 in response to a control signal of a demultiplexer controller 145. The plurality of data lines D₁ to Dₘ may further include capacitors C_{R}, C_{G} and C_{B} for storing voltages corresponding to data signals of the respective pixels 110.

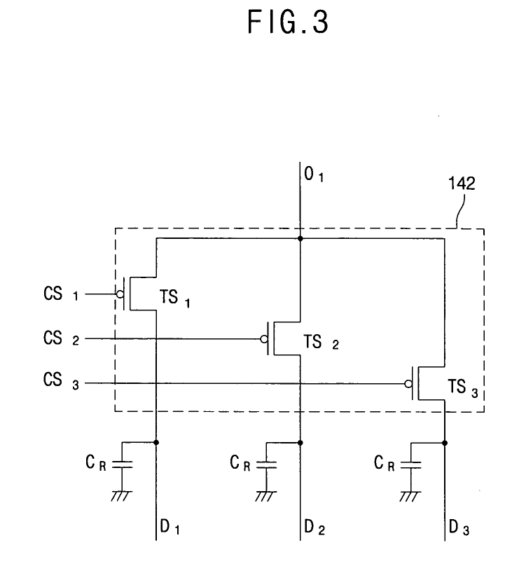

FIG. 3 is a circuit diagram of the demultiplexer electrically connected to a first output line of the data driver in the demultiplexer portion 140 of the flat panel display according to the first exemplary embodiment of the present invention.

Referring to FIG. 3, the demultiplexer 142 includes first to third data lines D₁ to D₃ electrically connected to respective pixels 110 of the pixel portion 100, a first switching transistor TS₁ disposed between the first data line D₁ and the output line O₁ of the data driver, a second switching transistor TS₂ disposed between the second data line D₂ and the output line O₁ of the data driver and a third switching transistor TS₃ disposed between the third data line D₃ and the output line O₁ of the data driver. The dimultiplexer 142 sequentially controls the first, second and third switching transistors TS₁, TS₂ and TS₃ in response to first to third control signals respectively supplied through first to third control interconnections CS₁ to CS₃.

The scan driver 130 generates scan signals in response to scan drive control signals suppled from the timing controller, and sequentially supplies the generated scan signals to the plurality of scan lines S₁ to Sₙ electrically connected to the pixel portion 100.

The lightning tester 160 is to supply a lighting test signal to the pixel portion 100 during a lighting test, which uses a test interconnection to which the lighting test signal is supplied as an initialization interconnection Vᵢₙₜ to which an initialization signal is supplied in the first exemplary embodiment of the present invention.

Furthermore, after the lighting test of the flat panel display according to the first exemplary embodiment of the present invention has been completed, an initialization transistor TI is turned on in response to the initialization signal during normal drive so as to supply the initialization signal to each pixel 110 using a lighting transistor and a lighting control interconnection for controlling the lighting test signal supplied to each pixel during the lighting test as the initialization transistor TI and an initialization control interconnection CI.

The lighting tester 160, as illustrated in FIG. 2, includes a plurality of initialization transistors TI disposed between a plurality of data lines D₁ to Dₘ electrically connected to the plurality of pixels 110 and the initialization interconnection Vᵢₙₜ, and all initialization transistors TI disposed between the plurality of data lines D₁ to Dₘ and the initialization interconnection Vᵢₙₜ are simultaneously controlled in response to an initialization control signal supplied through the initialization interconnection Vᵢₙₜ.

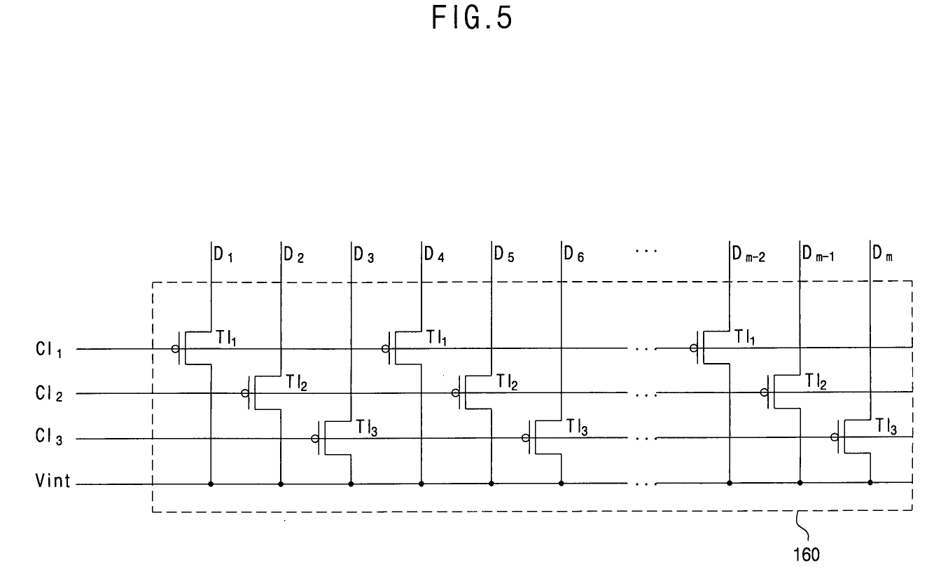

Alternatively, the lighting tester 160, as illustrated in FIG. 5, includes a first initialization transistor TI₁ controlled by a first control signal supplied through a first initialization control interconnection CI₁, a second initialization transistor TI₂ controlled by a second control signal supplied through the second initialization control interconnection CI₂ and a third initialization transistor TI₃ controlled by a third control signal supplied through a third initialization control interconnection CI₃, the transistors disposed between the plurality of data lines D₁ to Dₘ and the initialization interconnection Vᵢₙₜ.

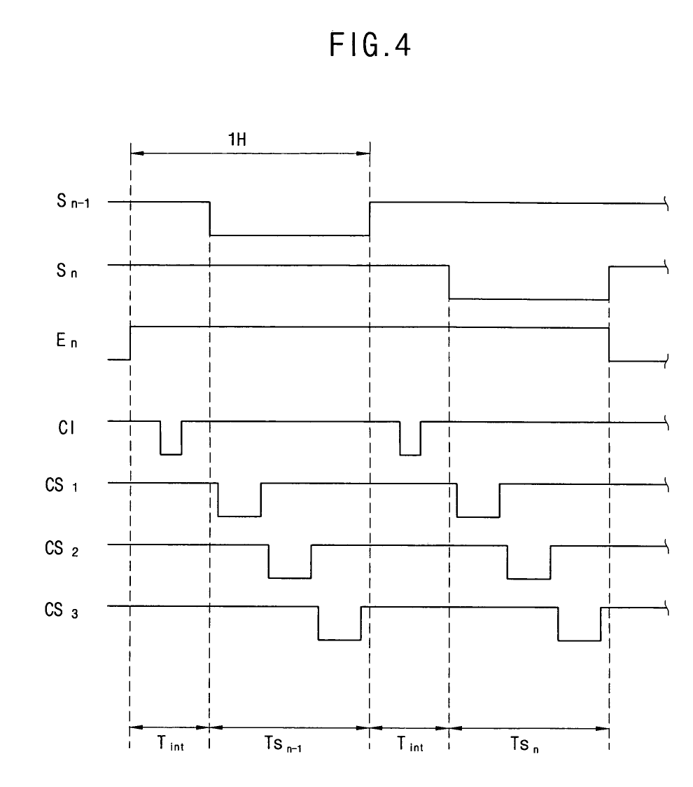

FIG. 4 is a timing diagram of signals supplied to the flat panel display according to the first exemplary embodiment of the present invention.

Referring to FIG. 4, a method of driving the flat panel display according to the first exemplary embodiment of the present invention includes dividing one horizontal period 1H into an initialization duration Tᵢₙₜ when a low-level initialization control signal is supplied through the initialization control interconnection CI and a current scan duration T_{Sn} when current scan signals are supplied through a plurality of scan lines S₁ to Sₙ.

During the initialization duration Tᵢₙₜ, the initialization transistor TI is turned on in response to the low-level initialization control signal, thereby electrically connecting the plurality of data lines D₁ to Dₘ to the initialization interconnection Vᵢₙₜ. Accordingly, the initialization signals are supplied to the plurality of data lines D₁ to Dₘ, and data signals which were supplied to the plurality of data lines D₁ to Dₘ during a previous scan duration T_{Sn-1} are initialized.

Subsequently, during the current scan duration T_{Sn} when the current scan signal is supplied, data signals are sequentially supplied to the plurality of data lines D₁ to Dₘ in response to first to third control signals supplied to the demultiplexer portion 140 through first to third control interconnections CS₁, CS₂ and CS₃ of the demultiplexer controller 145.

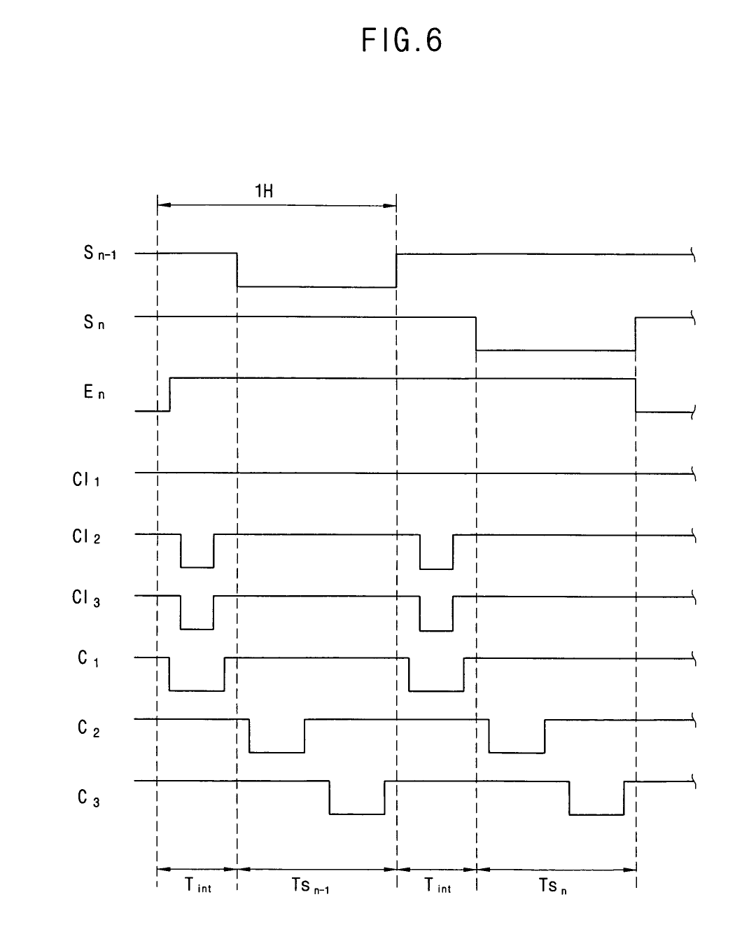

The lighting tester 160 according to the first exemplary embodiment of the present invention having the same structure as in FIG. 5, as illustrated in FIG. 6, controls the initialization signals and the data signals supplied to the plurality of data lines D₁ to Dₘ, thereby dividing the data lines D₁ to Dₘ into two groups. The lighting tester 160 supplies the initialization signals to one group of data lines D₂, D₃, D5, D6, . . . , Dₘ₋₁ and Dₘ and the data signals to the other group of data lines D₁, D₄, . . . , and Dₘ₋₂ during the initialization duration Tᵢₙₜ, and sequentially supplies the data signals to the group of data lines D₂, D₃, D5, D6, . . . , Dₘ₋₁ and Dₘ to which the initialization signals were supplied during the initialization duration Tᵢₙₜ during the current scan duration T_{Sn}.

As a result, the flat panel display according to the first exemplary embodiment of the present invention divides the horizontal period into the initialization duration and the current scan duration, initializes the data signals supplied in the previous scan duration during the initialization duration, supplies the current scan signals during the current scan duration, and sequentially supplies the data signals to the plurality of data lines, such that scan signals are supplied for a sufficiently long time period to the respective pixels.

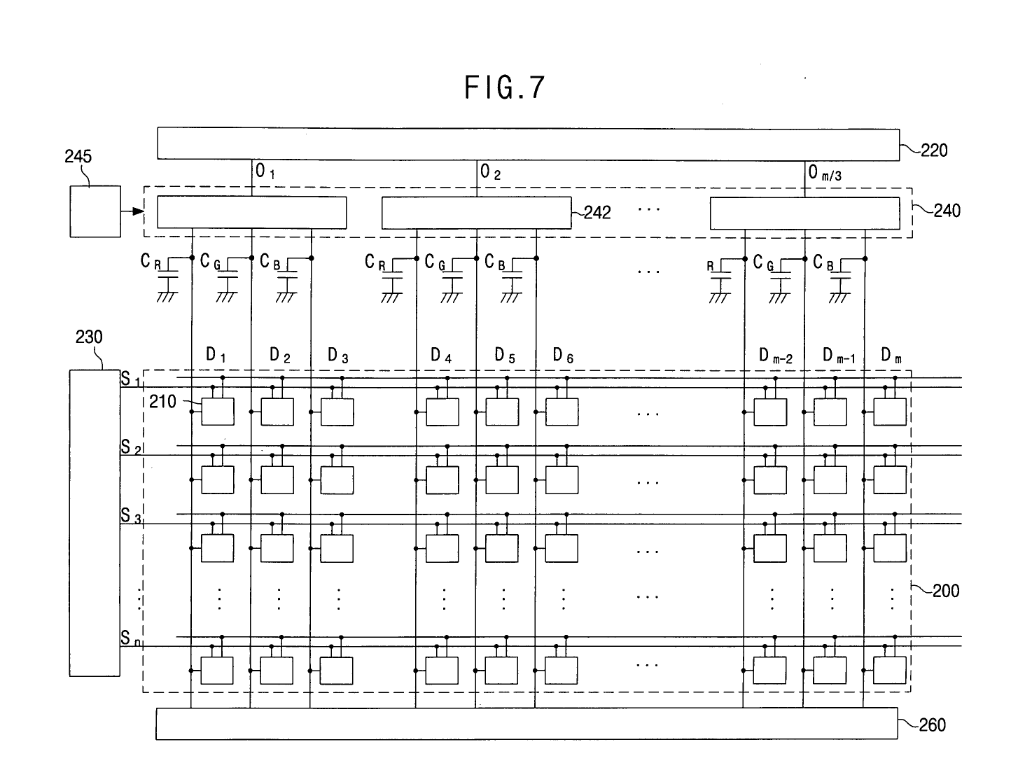

FIG. 7 is a schematic view of a flat panel display according to a second exemplary embodiment of the present invention.

Referring to FIG. 7, the flat panel display according to the second exemplary embodiment of the present invention includes a pixel portion 200 having a plurality of pixels 210, a scan driver 230 for supplying scan signals to the pixel portion 200, a data driver 220 for outputting data signals through a plurality of output lines O₁ to O_{m/3} and a dimultiplexer portion 240 having at least one dimultiplexer 242 sequentially supplying initialization signals and data signals through a plurality of data lines D₁ to Dₘ.

The data driver 220 converts digital image signals received from a timing controller (not illustrated) into data signals and supples the data signals to the dimultiplexer portion 240. The dimultiplexer 242 of the dimultiplexer portion 240 sequentially supplies the data signals to the pixel portion 200 through the plurality of data lines D₁ to Dₘ electrically connected therewith in response to control signals of a dimultiplexer controller 245, and supplies initialization signals to data lines D₁ to Dₘ no supplied with the data signals.

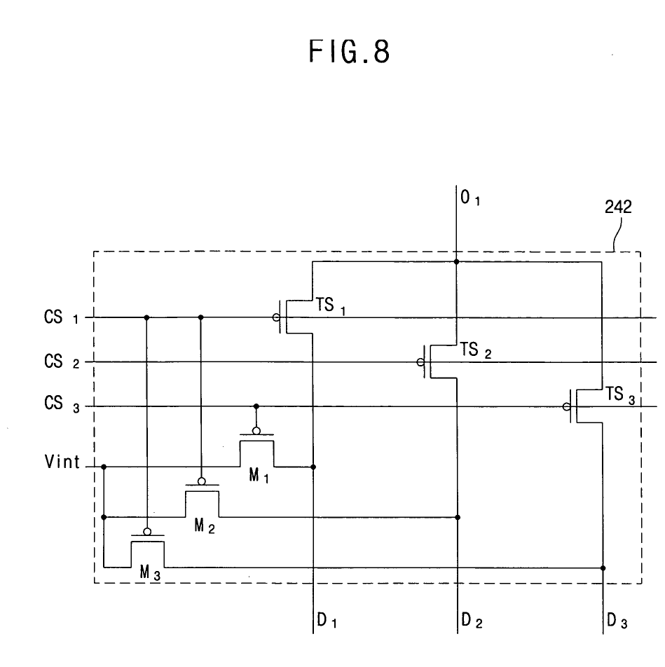

FIG. 8 is a circuit diagram of the dimultiplexer electrically connected to a first output line of the data driver in the dimultiplexer portion of the flat panel display according to the second exemplary embodiment of the present invention.

Referring to FIG. 8, the dimultiplexer 242 includes a first switching transistor TS₁ disposed between a first data line D₁ and an output line O₁ of the data driver, a second switching transistor TS₂ disposed between a second data line D₂ and the output line O₁ of the data driver, a third switching transistor TS₃ disposed between a third data lines D₃ and the output line O₁ of the data driver, a fourth initialization transistor M₁ disposed between an initialization interconnection Vᵢₙₜ and the first data line D₁, a fifth initialization transistor M₂ disposed between the initialization interconnection Vᵢₙₜ and the second data line D₂ and a sixth initialization transistor M₃ disposed between the initialization interconnection Vᵢₙₜ and the third data line D₃.

The fifth and sixth initialization transistors M₂ and M₃ are controlled by a first initialization control interconnection CS₁ supplying a first control signal to control the first switching transistor TS₁, and the fourth initialization transistor M₁ is controlled by a third initialization control interconnection CS₃ supplying a second control signal to control the third switching transistor TS₃.

While the fifth and sixth initialization transistors M₂ and M₃ are controlled by the first control signal to control the first switching transistor TS₁, and the fourth initialization transistor M₁ is controlled by the second control signal to control the third switching transistor TS₃ in the second exemplary embodiment of the present invention, in alternative embodiments, the fourth and fifth initialization transistors M₂ and M₃ may be controlled by the third control signal to control the third switching transistor TS₃, and the sixth initialization transistor M₁ may be controlled by the first control signal to control the first switching transistor TS₁.

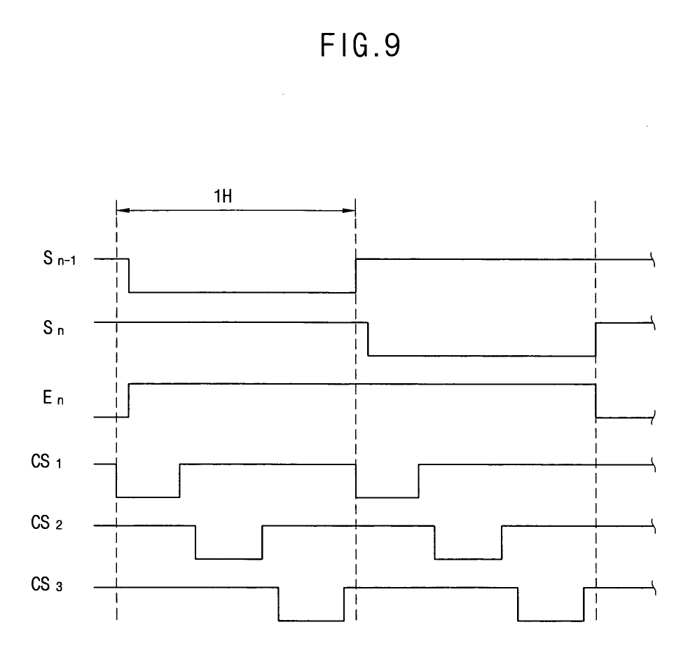

FIG. 9 is a timing diagram of signals supplied to the flat panel display according to the second exemplary embodiment of the present invention.

Referring to FIG. 9, a method of driving the flat panel display according to the second exemplary embodiment of the present invention includes supplying a current scan signal during one horizontal period 1H, and then sequentially supplying the first to third control signals to the dimultiplexer 242 from the dimultiplexer controller 245 while the current scan signals are supplied.

As described above, the first control signal supplied to the dimultiplexer 242 turns on the 11 first switching transistor TS₁, the second initialization transistor M₂ and the third initialization transistor M₃, so that a data signal is supplied to the first data line D₁, and initialization signals are supplied to the second and third data lines D₂ and D₃.

Furthermore, the second control signal supplied to the dimultiplexer 242 turns on the second switching transistor TS₂, so that a data signal is supplied to the second data line D₂, and the third control signal of the dimultiplexer 242 turns on the third switching transistor TS₃ and the first initialization transistor M₁, so that a data signal is supplied to the third data line D₃, and an initialization signal is supplied to the first data line D₁.

As a result, the flat panel display according to the second exemplary embodiment of the present invention supplies scan signals during the horizontal period, sequentially electrically connects the data lines electrically connected to the pixel portion and the data driver in response to the control signals of the dimultiplexer, and electrically connects at least one of the plurality of data lines not connected to the data driver to the initialization interconnections to which the initialization signals were supplied, such that the scan signals are sufficiently supplied to the respective pixels.

Consequently, in a flat panel display and a method of driving the flat panel display according to the present invention, an initialization signal is supplied to a data line which is not electrically connected to a data driver before or while a scan signal is supplied to each pixel, and a data signal is supplied to the pixel while the scan signal is supplied, such that distortion or deformation of the data signal supplied to the pixel is prevented, and a duration of the scan signal is sufficiently long to compensate for a threshold voltage of a drive transistor.

Although exemplary embodiments of the present invention have been shown and described, it would be appreciated by those skilled in the art that modifications maybe made to these embodiments without departing from the principles and spirit of the present invention, the scope of which is defined by the following claims.

What is claimed is:

1. A flat panel display, comprising:
a pixel portion having a plurality of pixels;
a scan driver to supply a scan signal to the pixel portion;
a data driver to generating a data signal;
a dimultiplexer portion to sequentially supply the data signal to the pixel portion; and
a lighting tester to supply a lighting test signal and an initialization signal to the pixel portion.

2. The display according to claim 1, wherein the demultiplexer portion comprises:
a plurality of data lines electrically connected to the pixel portion;
a plurality of switching transistors to electrically connect the data lines to the data driver in response to control signals; and
a plurality of control lines to supply the control signals to the plurality of switching transistors.

3. The display according to claim 2, wherein the lighting tester comprises an initialization interconnection to receive the initialization signal, and an initialization transistor arranged between the initialization interconnection and the data line.

4. The display according to claim 2, wherein the plurality of pixels respectively display different colors and are respectively connected to their respective data lines, and wherein the lighting tester comprises:
an initialization interconnection to receive the initialization signal;
a plurality of initialization transistors arranged between the initialization interconnection and the data lines; and
at least one initialization control interconnection to receive a control signal to control the plurality of initialization transistors.

5. The display according to claim 4, wherein the pixel portion includes red, green and blue pixels, and wherein the lighting tester comprises:
a first initialization transistor arranged between a first data line electrically connected to the red pixel and the initialization interconnection;
a second initialization transistor arranged between a second data line electrically connected to the green pixel and the initialization interconnection; and
a third initialization transistor arranged between a third data line electrically connected to the blue pixel and the initialization interconnection.

6. The display according to claim 5, wherein the initialization control interconnection comprises:
a first initialization control interconnection to receive a first control signal to control the first initialization transistor;
a second initialization control interconnection to receive a second control signal to control the second initialization transistor; and
a third initialization control interconnection to receive a third control signal to control the third initialization transistor.

7. The display according to claim 1, wherein the dimultiplexer comprises a plurality of data lines to supply the data signals to the pixel portion, each data line including a capacitor to store a voltage corresponding to the data signal.

8. A flat panel display, comprising:
a pixel portion having a plurality of pixels;
a scan driver to supply a scan signal to the pixel portion;
a data driver to output a data signal; and
a dimultiplexer portion to sequentially supply an initialization signal and the data signal to the pixel portion.

9. The display according to claim 8, wherein the dimultiplexer portion comprises:
an initialization interconnection to receive the initialization signal;
a plurality of data lines electrically connected to the pixel portion;
a plurality of switching transistors to electrically connect the data driver to the data lines in response to control signals;
a plurality of control lines to supply the control signals to the plurality of switching transistors; and
a plurality of initialization transistors to electrically connect the initialization interconnection to the data lines in response to the control signals.

10. The display according to claim 9, wherein each initialization transistor is arranged between the initialization interconnection and at least one of the plurality of data lines other than the data lines connected to the data driver in response to a control signal supplied by a control interconnection connected to a gate terminal.

11. The display according to claim 9, wherein the pixel portion includes red, green and blue pixels, and wherein the dimultiplexer portion comprises:
a first switching transistor arranged between a first data line electrically connected to the red pixel and the data driver;
a second switching transistor arranged between a second data line electrically connected to the green pixel and the data driver;
a third switching transistor arranged between a third data line electrically connected to the blue pixel and the data driver;
a fourth initialization transistor arranged between the initialization interconnection and the first data line;
a fifth initialization transistor arranged between the initialization interconnection and the second data line; and
a sixth initialization transistor arranged between the initialization interconnection and the third data line.

12. The display according to claim 11, further comprising:
a fourth initialization control interconnection to supply a first control signal to control one or all of the fifth and sixth initialization transistors and the first switching transistor;
a fifth initialization control interconnection to supply a second control signal to control one or all of the fourth and sixth initialization transistors and the second switching transistor; and
a sixth initialization control interconnection to supply a third control signal to control one or all of the fourth and fifth initialization transistors and the third switching transistor.

13. The display according to claim 8, wherein the dimultiplexer comprises a plurality of data lines to supply the data signals to the pixel portion, each data line including a capacitor to store a voltage corresponding to the data signal.

14. A method of driving a flat panel display, including a scan driver, a data driver, a pixel portion having a plurality of pixels and a lighting tester, to sequentially supply data signals to the pixel portion using a demultiplexer, the method comprising:
supplying an initialization signal to a test interconnection of the lighting tester;
electrically connecting the test interconnection to a plurality of data lines electrically connected to the pixel portion in response to a control signal of the lighting tester, and supplying the initialization signal to the pixel portion;
supplying a scan signal to the pixel portion; and
sequentially supplying a data signal to the pixel portion during the supplying of the scan signal to the pixel portion.

15. The method according to claim 14, wherein the data lines are connected to pixels displaying different colors, and wherein the lighting tester sequentially supplies initialization signals to the data lines in response to control signals.

16. The method according to claim 14, wherein the initialization signals have a relatively higher voltage level than the maximum voltage level of the data signal.

17. A method of driving a flat panel display, including a scan driver, a data driver and a pixel portion having a plurality of pixels, to sequentially supply data signals to the pixel portion using a dimultiplexer, the method comprising:
dividing one horizontal period into a first period and a second period;
dividing a plurality of data lines into a first group and a second group, the plurality of data lines electrically connecting the plurality of pixels to the dimultiplexer;
supplying initialization signals to the data lines of the first group during the first period;
sequentially supplying data signals to the data lines of the second group during the first period;
supplying scan signals to the pixel portion during the second period; and
sequentially supplying data signals to the data lines of the first group during the second period of supplying the scan signals.

18. The method according to claim 17, wherein the data lines are electrically connected to pixels displaying different colors, and wherein the data lines are divided into the first and second groups according to the colors displayed by the pixels electrically connected to the data lines.

19. The method according to claim 17, wherein the initialization signals have a relatively higher voltage level than the maximum voltage level of the data signal.

20. The method according to claim 17, further comprising:
sequentially turning on a plurality of switching transistors electrically connected between the data lines of the second group and the data driver in response to a control signal during the first period, and turning on initialization transistors electrically connected between the data lines of the first group and an initialization interconnection.

21. A method of driving a flat panel display, including a data driver, a scan driver and a pixel portion having a plurality of pixels, and sequentially supplying data signals to the pixel portion using a dimultiplexer, the method comprising:
supplying scan signals during one horizontal period;
sequentially electrically connecting the data lines, electrically connected to the pixel portion, to the data driver in response to control signals; and
electrically connecting at least one of the plurality of data lines, not connected to the data driver, to an initialization interconnection having an initialization signal supplied thereto in response to the control signals.

22. The method according to claim 21, wherein the data lines are electrically connected to the initialization interconnection, before being electrically connected to the data driver.

23. The method according to claim 21, wherein the control signal simultaneously turns on a switching transistor electrically connected between one of the plurality of data lines and the data driver, and an initialization transistor electrically connecting at least one of the data lines adjacent to the data line to the initialization interconnection.

24. The method according to claim 21, wherein the pixel portion comprises: first, second and third pixels to respectively display first, second and third colors, and wherein the plurality of data lines comprise a first data line electrically connected to the first pixel, a second data line electrically connected to the second pixel and a third data line electrically connected to the third pixel;
wherein the first data line is electrically connected to the data driver in response to a first control signal;
one or both of the second and third data lines is electrically connected to the initialization interconnection in response to the first control signal, the second data line is electrically connected to the data driver in response to a second control signal;
one or both of the first and third data lines is electrically connected to the initialization interconnection in response to the second control signal;
the third data line is electrically connected to the data driver in response to a third control signal; and
one or both of the first and second data lines is electrically connected to the initialization interconnection in response to the third control signal.
